(19) United States
(12) Patent Application Publication
(10) Pub. No.: US 2008/0126819 A1
(43) Pub. Date: May 29, 2008

(54) METHOD FOR DYNAMIC REDUNDANCY OF PROCESSING UNITS

(75) Inventors: Jacob L. Moilanen, Austin, TX (US); Joel H. Schopp, Austin, TX (US); Michael T. Strosaker, Austin, TX (US)

Correspondence Address: CANTOR COLBURN LLP - IBM AUSTIN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/564,593

(22) Filed: Nov. 29, 2006

(51) Int. Cl. G06F 9/46; G06F 1/00

(52) U.S. Cl. 713/375; 718/102

(57) ABSTRACT

A method for dynamic redundancy of processing units. The method includes defining at least one of, (i) an instruction, and (ii) a call, to idle a first processing unit. Both the instruction and the call are blocking operations that shall not return while a second processing unit and the first processing unit are paired together. The method further includes executing at least one of, (i) the defined instruction, and (ii) the call, and temporarily stopping the paired processing unit. Then, the method proceeds by synchronizing the state and enabling the redundant processor execution. Afterwards, the method includes restarting execution of both processing units together.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of Invention

This invention relates in general to processing units, and more particularly to dynamic redundancy of processing units.

2. Description of Background

Processors sometimes fail in the field. Failing processors are very rare, but it does happen. That is why systems like IBM zSeries have redundancy built into their processors to check execution of instructions. However, this redundancy is very expensive because it essentially requires twice the number of processors. Because of the cost, most commodity systems such as PowerPC, Opteron, Cell, etc., do not have redundant processor execution.

However, as the number of processing units increase and the manufacturing process continues to shrink, the possibility of undetected errors in the processor occurring becomes more and more likely. This is especially true on the cell architecture, which has eight (8) special purpose units for each processor.

Thus, there is a need for a method for dynamic redundancy of processing units.

### SUMMARY OF THE INVENTION

The shortcomings of the prior art are overcome and additional advantages are provided through the provision of a method for dynamic redundancy of processing units. The method includes defining an instruction to idle a first processing unit. The instruction being a blocking operation that shall not return while a second processing unit and the first processing unit are paired together. The method further includes executing the defined instruction and temporarily stopping the paired processing unit. The method proceeds by synchronizing the state and enabling the comparison logic portion of the pipeline. Then, the method proceeds by restarting execution of both processing units together.

The shortcomings of the prior art are overcome and additional advantages are provided through the provision of a method for dynamic redundancy of processing units where the processors are activated in redundant mode and dynamically decoupled. The method includes delivering a signal to the first processing unit from a scheduler when there is new work for the first processing unit to perform, such that the first processing unit shall no longer be idle. The method further includes returning the first processing unit from at least one of, (i) an instruction, and (ii) a call, that caused the first processing unit to join the second processing unit. Then, the method further includes resuming processing by the first processing unit.

Additional features and advantages are realized through the techniques of the present invention. Other embodiments and aspects of the invention are described in detail herein and are considered a part of the claimed invention. For a better understanding of the invention with advantages and features, refer to the description and to the drawing.

### TECHNICAL EFFECTS

As a result of the summarized invention, technically we have achieved a solution for a method for dynamic redundancy of processing units. Furthermore, we have achieved a solution for a method for dynamic redundancy of processing units where the processors are activated in redundant mode and dynamically decoupled.

### BRIEF DESCRIPTION OF THE DRAWINGS

The subject regarded as the invention is particularly pointed out and distinctly claimed in the claims at the conclusion of the specification. The foregoing and other objects, features, and advantages of the invention are apparent from the following detailed description taken in conjunction with the accompanying drawing in which:

FIG. 1 illustrates one example of a method for dynamic redundancy of processing units; and

FIG. 2 illustrates one example of a method for redundancy of processing units where the processors are activated in redundant mode and dynamically decoupled.

The detailed description explains an exemplary embodiment of the invention, together with advantages and features, by way of example with reference to the drawing.

### DETAILED DESCRIPTION OF THE INVENTION

The disclosed method addresses synergistic processing units for cell processors. All processing units in the system are paired into buddies. When a processing unit goes idle a special instruction or hypervisor call in the idle code causes the idle processor to sync to the state of its buddy and simultaneously execute with the buddy. Only when both buddies go idle will a processing unit actually idle. On systems that would otherwise not be idle, but which would desire the higher reliability, the scheduler could force one buddy of each pair to always be idle. This allows the choice of higher performance or higher reliability to be made at the operating system (OS) level and changed on the fly.

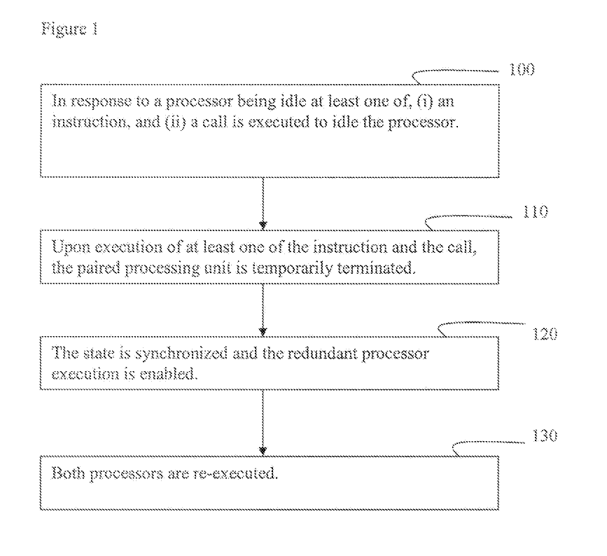

Referring to FIG. 1, a method for dynamic redundancy of processing units is shown. At step 100, an instruction or a call to idle a first processing unit is defined. The call may be a special hypervisor call or a processor instruction. In either scenario, the instruction or call is utilized as a blocking operation. Neither the instruction nor the call shall return while a second processing unit and the first processing unit is paired together to form a buddy processing unit.

At step 110, the defined instruction is executed, and the buddy processing unit is temporarily stopped. Then, at step 120, the state is synchronized and the redundant processor execution is enabled. Subsequently, at step 130, both processing units, the first and the second processor unit, will restart execustion together.

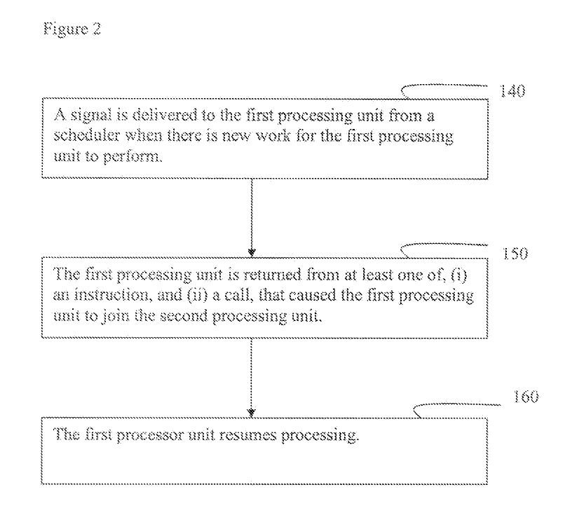

Referring to FIG. 2, an alternative embodiment of the disclosed method is shown. The alternative embodiment addresses how to return to normal operation when the processors are started in a redundant mode and dynamically decoupled.

At step 140, a signal is delivered to the first processing unit from the remote scheduler when there is new work for the first processing unit to execute, such that the first processing unit will no longer be idle. When the signal is received, the redundant processor execution shall be disabled.

Afterwards at step 150, the first processing unit shall return from the instruction or the call that activated the first processor unit to join with the second processor unit, the first processor's buddy unit. Then at step 160, the first processor unit shall resume processing just as the first processor unit processed prior to the instruction or the call that was executed.

The operating system idle loop will have to be modified to execute the new instruction or new call. Idle load balancing may have to be modified on some systems. Yet, very little would change in the operating system to accommodate this increased redundancy.

For systems that were manually set into redundant mode, the operating system may want to hot-unplug the processing unit so that information about the operating unit as an independent unit does not get presented to performance critical applications. Thus, if an eight (8) synergistic processor unit (SPU) had only four (4) SPUs available due to redundancy something like a universal database (DB2) would only run four (4) threads.

Systems with shared processors, such as Xen, could enable the dedicated redundancy underneath the operating system, such that all presented processors were redundant provided the processors were configured that way. The hypervisor call could also implement the dynamic redundancy on idle through existing methods for ceding processors. Neither one of these methods would require modification of the operating system.

While the preferred embodiment to the invention has been described, it will be understood that those skilled in the are, both now and in the future, may make various improvements and enhancements which fall within the scope of the claims which follow. These claims should be construed to maintain the proper protection for the invention first described.

What is claimed is:

1. A method for dynamic redundancy of processing units, including:
defining at least one of, (i) an instruction, and (ii) a call, to idle a first processing unit, such instruction and call being a blocking operation that shall not return while a second processing unit and the first processing unit are paired together;
executing at least one of, (i) the instruction, and (ii) the call and temporarily stopping the paired processing unit;
synchronizing the state and enabling the redundant processor execution; and
restarting execution of both processing units together.

2. A method for dynamic redundancy of processing units where the processors are activated in redundant mode and dynamically decoupled, including:
delivering a signal to the first processing unit from a scheduler when there is new work for the first processing unit to perform, such that the first processing unit shall no longer be idle;
returning the first processing unit from at least one of, (i) and instruction, and (ii) a call, that caused the first processing unit to join the second processing unit; and
resuming processing by the first processing unit.

3. The method of claim 2, wherein when the special signal is received, the redundant processor execution shall be disabled.
